(19) United States
(12) Patent Application Publication
(10) Pub. No.: US 2017/0284126 A1
(43) Pub. Date: Oct. 5, 2017

(54) ENHANCED DOUBLE CYLINDER LOCK AND WITH ACTUATION DETECTION

(71) Applicant: ETABLISSEMENTS DECAYEUX, Feuquiéres en Vimeu (FR)

(72) Inventor: Antoine Decayeux, Feuquiéres en Vimeu (FR)

(73) Assignee: ETABLISSEMENTS DECAYEUX, Feuquiéres en Vimeu (FR)

(21) Appl. No.: 15/477,703

(22) Filed: Apr. 3, 2017

(30) Foreign Application Priority Data
Apr. 4, 2016 (FR) 1652934

(51) Int. Cl. E05B 35/10; E05B 65/52; E05B 39/00

(52) U.S. Cl. CPC E05B 35/10; E05B 39/00; E05B 65/52

(57) ABSTRACT

A double cylinder lock is disclosed which includes a first of the cylinders, called a service cylinder, being actuatable by a first key, the second of the cylinders, called a customer cylinder, being actuatable by a second key distinct from the first key, wherein the service cylinder may only be actuated once at most between two actuations of the customer cylinder the lock also including a module for detecting the actuation of the service cylinder.

### CROSS-REFERENCE TO RELATED APPLICATIONS

This application claims priority to French Patent Application No. 1652934, filed on Apr. 4, 2016, which is incorporated by reference herein.

### BACKGROUND AND SUMMARY

The present invention relates to an enhanced double cylinder lock and with transmission of information. More particularly, the invention relates to a secured lock for mailboxes and package boxes. In the present description and in the claims to which it gives rise, by “mailbox” are meant both letter boxes strictly speaking and package boxes.

In the field of locks, security is a criterion of a primordial choice for the user. In the state of the art, double cylinder locks are notably known, one of which, called a service cylinder, is actuatable both by a customer key and by a service key, distinct from said customer key and the other one, called a customer key, is exclusively actuatable by said customer key. In other words, the customer cylinder has the function of blocking or authorizing the actuation of the service cylinder with the service key. The customer key therefore has two positions:
a position in which the service cylinder may be actuated indefinitely with the service key,
a position in which the service cylinder can absolutely not be actuated with the service key, but only with the customer key.

These locks therefore do not allow an exclusive actuation of the service cylinder between two actuations of the customer cylinder. This is particularly a pity for letter box locks which are opened by delivery persons provided with master keys, but are increasingly often burgled (without any forced break-in) by thieves which have this type of key.

Further, another drawback of known locks is that the customer does not have the possibility of knowing when the service key has been used. Thus, in order to know whether a letter or a package was deposited in the mailbox, the customer should verify by himself/herself by opening physically the mailbox. Therefore there exists a real need for solving the technical problem discussed earlier.

For this purpose, the present invention proposes a double cylinder lock, the first of said cylinders, called a service cylinder, being actuatable by a first key, the second of said cylinders, called a customer cylinder, being actuatable by a second key distinct from the first key, wherein the service cylinder may only be actuated once at most between two actuations of the customer cylinder, the lock also including modules for detecting the actuation of the service cylinder. By means of these arrangements, after the deposition of a package in the mailbox and the closing of said box, master keys become totally inoperative since said box can only be opened with the key of its owner.

According to an alternative, the lock further includes a closure plate and a casing in which the service cylinder and the customer cylinder are accommodated, the closure plate being configured for closing the casing, the detection module including:
a pin configured so as to be displaced by the service cylinder into a triggering position when the service cylinder is actuated, the pin being configured for protruding out of the casing or of the closure plate through a detection orifice formed in the casing or the closure plate, respectively;
a triggering module configured so as to be triggered by the pin when the pin is displaced into the triggering position.
   According to an alternative, the lock further includes a communication module configured for transmitting a piece of information relative to the detection of the actuation of the service cylinder by the detection module. According to an alternative, the communication module is configured for wireless transmitting a piece of information, preferably by sending an SMS or e-mail.

According to particular features, the lock according to the invention further includes:
a lock chamber at the bottom of which is provided a notch with a circular arc shape,
a pivoting clutch disc comprising a tube sliding within said notch between the disengaged position and the engaged position.
   According to particular features,
the disc has a through-bore arranged in the extension of the tube,
the tube includes, at its rear end, a shrinked portion,
said lock further includes a spring positioned within said tube,
the clutch is positioned within said tube and comprises a cylindrical body and a head.
   According to particular features, the body of the clutch
has a flange for which the diameter is similar to an inner diameter of the tube and to an outer diameter of the spring so that said spring is positioned between the shrinked portion of the tube and the flange of said clutch,
crosses the bore of the disc on one side and crosses said shrinked portion on the other side so that the head of said clutch is on the rear side of the lock chamber.

According to particular features,
the lock according to the invention further includes a so-called surface bit comprising a protrusion, an oblong notch and an orifice,
said notch receives a rotor of the service cylinder,
said orifice receives the body of the clutch during the actuation of said service cylinder.
   According to particular features,
the lock according to the invention further includes a bolt comprising an oblong notch and an orifice, said bolt is attached to the lock chamber,
the notch of said bolt receives the service cylinder,
the orifice of said bolt receives the body of the clutch when the clutch is in the engaged position.
According to particular features,
   the lock according to the invention further includes a so called customer bit comprising a protrusion and an oblong notch,
   the notch of said customer bit receives a rotor of the customer cylinder.
      According to particular features, the lock according to the invention further includes
   a bolt having two lower notches and an oblong notch, one of said notches being adapted for receiving the protrusion of the service bit, the other one of said notches being adapted for receiving the protrusion of the customer bit,
   a groove applied against a front face of the bolt on which it is mounted so as to be free in rotation, said groove having a side notch,
   a square attached on the bottom of the lock chamber and adapted so as to slide within the notch of the bolt and within the notch of the groove.

The object of the invention is also a method for operating such a lock, wherein, after locking the lock by actuating the customer key, the unlocking of the lock may be carried out by actuating either one of the cylinders, and in that after the locking the lock by actuating the service cylinder, the unlocking is only possible by actuating the customer cylinder. The object of the invention is also a letterbox including such a lock. By these arrangements, the owner of the mailbox may only allow a single access to his/her box when he/she is waiting for a package. In other words, any individual provided with a master key can open the mailbox after delivery of a package. Only the owner may recover the package by means of his/her customer key which is specific to him/her.

### BRIEF DESCRIPTION OF THE DRAWINGS

Other features and advantages of the invention will become apparent upon reading the description which follows of a preferred embodiment of the invention, given as an example and with reference to the appended drawings, wherein:

FIG. 1 shows an oblique perspective exploded view of an exemplary enhanced lock according to the invention;

FIGS. 2A and 2B show two sectional views of the same exemplary lock according to the invention in a disengaged position;

FIGS. 3A and 3B show two sectional views of the same example of a lock according to the invention in a semi-engaged position;

FIGS. 4A and 4B show two sectional views of the same exemplary lock according to the invention in an engaged position; and

FIG. 5, shows another example of an enhanced lock comprising a detection module.

### DETAILED DESCRIPTION

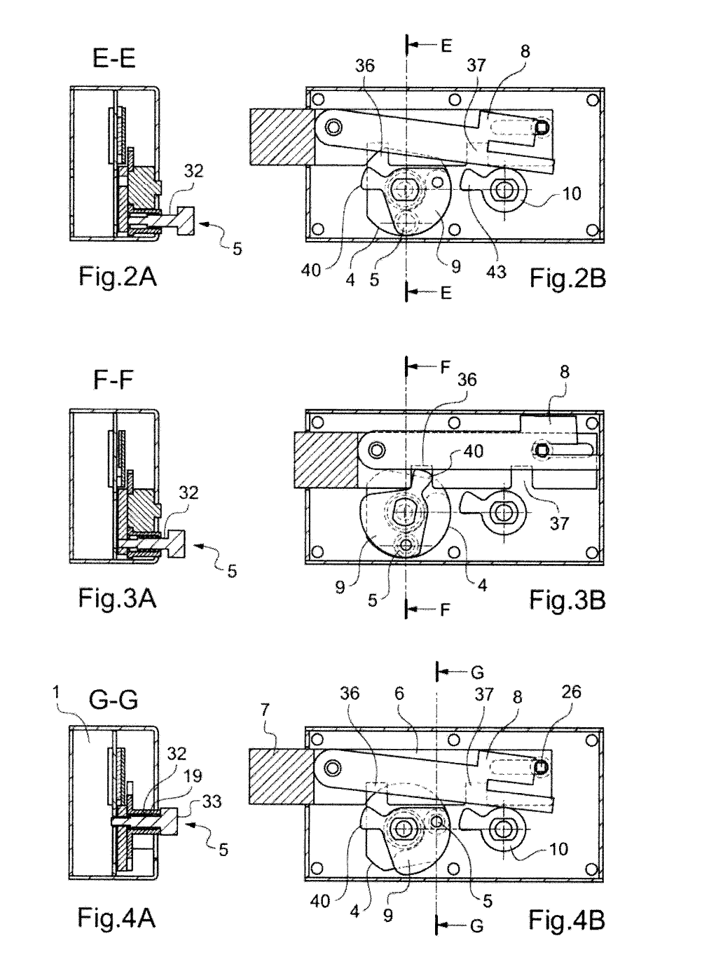

In the following description, identical elements or with identical function bears the same reference symbol. In order to make the present description more concise, elements identical with different examples are not described with regard to each of these examples. In other words, only the differences between the different examples are described in a detailed way, the common elements being described with regard to a single example. FIGS. 2A, 3A and 4A are sectional views respectively formed along the planes EE, FF and GG illustrated in FIGS. 2B, 3B and 4B.

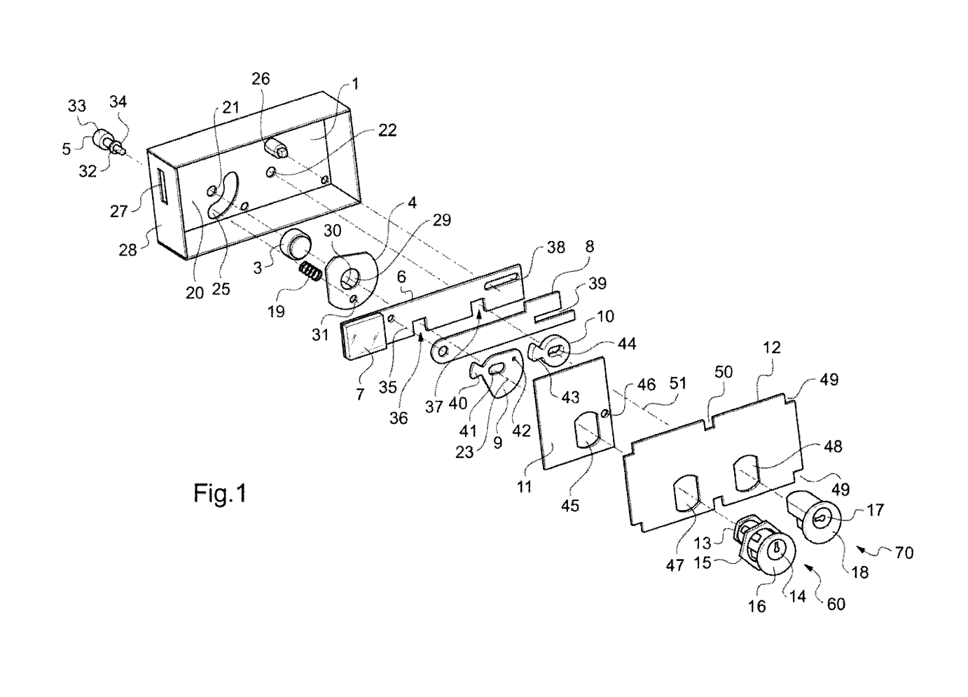

FIG. 1 illustrates an embodiment of an enhanced lock 100 according to the invention intended to be installed in a mailbox. In one alternative, the lock according to the invention may be attached on a door or on any other opening element. The lock 100 includes a lock chamber 1 intended to be attached on a door of the mailbox so that a flat bottom 20 of said lock chamber extends along a plane parallel to a plane formed by said door. The bottom 21 has two circular orifices 21 and 22, a notch 25 with shape of a circular arc, and a pillar 2 including a square 26. Finally, a slot 27 is made on a side face of the lock chamber 28.

The lock 100 further includes a support 3 penetrating, on one side, the orifice 21 of the lock chamber 1 and, on the opposite side, a first bore 29 of a pivoting clutch disc 4 so that one face of said support, conventionally called a front face, is flushed with a front face of said disc. The clutch disc 4 includes a tube 30 extending perpendicularly to its plane and crossing the notch 25 with a circular arc shape. The disc 4 has a second through-bore 31 arranged in the extension of the tube 30. The tube 30 includes, at its rear end, a shrinked portion.

The tube 30 receives a clutch 5 and a spring 19 within it. The clutch 5 includes a cylindrical body 32 and a head 33. The body 32 has a flange 34 the diameter of which is similar to an inner diameter of the tube 30 and to an outer diameter of said spring so that the spring 19 is positioned between the shrinked portion of said tube and the flange. The body 32 penetrates the bore 31 so that its front end, by means of the spring 19 presses onto the front face of the disc 4 and crosses the shrinked portion of the tube 30 so that the head 33 of the clutch 5 is on the rear side of the lock chamber 1.

The lock 100 further includes a bolt 6 appearing as a plate with a global rectangular profile and applied against the front face of the disc 4. The bolt 6 has a lower service notch 36, a lower customer notch 37, as well as an oblong notch 38. The bolt is positioned so as to be able to move to and fro in translation within the side slot 27 of the lock chamber 1. Preferably, the bolt 6 has a length greater than or equal to one length of the lock chamber 1.

The lock 100 further includes a groove 8 appearing as a profile plate applied against the front face of the bolt 6 on which it is mounted so as to rotate freely around an axis 35 perpendicular to the plane along which said groove extends. The groove 8 has a side notch 39, on a side opposite to the one where the axis of rotation 35 of said groove is provided. The oblong notch 38 and the side notch 39 have a similar separation on one side of the square 26 so that said notch and said notch slide around said square during operation of the lock 100. In other words, the square 26 is adapted for sliding within the oblong notch 38 and the side notch 39.

The lock 100 further includes a so called service bit 9 and a so called customer bit 10 both appearing as profiled plates. The service bit 9 has a protrusion 40, an oblong notch 41 and a circular orifice 42. The customer bit 10 has a protrusion 43 and an oblong notch 44. The orifice 42 is adapted for receiving the body 32. In the example, the disc 4 and the bit 9 are disc portions.

The lock 100 further includes a latch 11 appearing as a globally rectangular plate applied against the front face of the bit 9. The latch 11 has an oblong notch 45 and a circular orifice 46. Preferably, the latch 11 has a height substantially equal to a height of the lock chamber 1 to which said latch is attached.

The lock 100 further includes a strike plate 12 closing the front face of the lock chamber 1 and appearing as a globally rectangular plate applied against the front face of the latch 11. The strike plate 12 has two oblong notches 47 and 48 as well as four notches 49 made in its angles and two notches 50 made in the middle of its upper and lower edges. Preferably, the strike plate 12 has a height substantially equal to that of the lock chamber 1 and a length substantially equal to that of said lock chamber. The oblong notch 47 is positioned facing that of the latch 11.

The lock 100 further includes a so called cam or cylinder 60 and a so called customer cam or cylinder 70. The cylinder 60 is able and intended to receive a so called service key, or called a master key, not shown and the cylinder 70 is able and intended to receive a single so called customer key not shown, said second key being necessarily distinct from said first key.

The cylinder 60, positioned within oblong notches 45 and 47 which fit its shape, includes a rotor 14, a stator 16 and two attachment nuts 13 and 15. A rear end of the rotor 14 is positioned within the oblong notch 41 of the service bit 9. The service key is intended to be inserted into a front end of the rotor 14 so as to have it pivot around an axis of rotation 23 extending through the notch 41, of the bore 29 of the support 4 and of the orifice 21 of the lock chamber 1.

The cylinder 70, positioned within the oblong notch 48 which fits its shape, includes a rotor 17, a stator 18 and attachment means. A rear end of the rotor 17 is positioned within the oblong notch 44 of the customer bit 10. The customer key is intended to be inserted into a front end of the rotor 17 so as to have it pivot around an axis of rotation 51 extending through the notch 44 and the orifice 22 of the lock chamber 1.

FIGS. 2A and 2B represent two sectional views of the same exemplary lock 100 in a disengaged position. In this position, the mailbox is closed and may be opened either by actuating the service cylinder, or by actuation of the customer cylinder. The front end of the body 32 of the clutch 5 is supported on the rear face of the service bit 9, the groove 8 is supported, because of gravity, on an edge of the customer bit 10 and the bolt 6 is exposed. Moreover, the protrusion 40 of the bit 9 is not engaged into the notch 36 of the groove 8 and the protrusion 43 of the bit 10 is not engaged into the notch 37 of said groove.

FIGS. 3A and 3B represent two sectional views of the same exemplary lock according to the invention in a semi-engaged position. In this position, the mailbox is open, the bit 9 has performed a clockwise rotation of about 90°, i.e. a quarter of a turn, due to the actuation of the service cylinder, i.e. at the pivot of its rotor 14 under the action of service personnel. This rotation engages the protrusion 40 into the lower service notch 36 of the bolt 6, and then lifts the groove 8 until a lower edge of its side notch 39 comes into abutment and slides against the square 26. Moreover, this rotation aligns the orifice 42 of the bit 9 and the clutch 5. Consequently, the end of the clutch 5 opposite to its head 33 penetrates into the orifice 42 under the action of the spring 19.

FIGS. 4A and 4B represent two sectional views of the same exemplary lock according to the invention in an engaged position. In this position, the mailbox was closed and can only be opened again by actuating the customer cylinder. The bit 9 and the clutch disc 4 have performed an anti-clockwise rotation of about 90° due to the actuation of the service cylinder. This rotation disengages the protrusion 40 of the lower service notch 36 of the bolt 6, and then withdraws the groove 8 until the square 26 leaves its side notch 39. Moreover, this rotation aligns the orifice 46 of the latch 11 and the clutch 5. Consequently, the end of the clutch 5 opposite to its head 33 penetrates into the orifice 46 under the action of the spring 19, which blocks any actuation of the service cylinder 60.

In this engaged position, if the customer wishes that his/her mailbox be again able to open at most once by a service personnel, he should open it and rearm the lock 100, i.e. by manually disengaging the clutch 5 by pulling its top and by sliding, with the clutch disc 4, within the notch 25 between the disengaged position (high) and the engaged position (low). By opening the mailbox after the service personnel, the owner actuates with his/her customer key the customer cylinder by turning it a quarter of a turn in the clockwise direction, which causes pivoting of the bit 10 by as much. The extrusion 43 of the bit 10 then engages into the lower service notch 37 of the bolt 6 which begins to slide around the square 26, and then lifts the groove 8 until the lower end of its lateral notch 39 will abut and slide against the square 26.

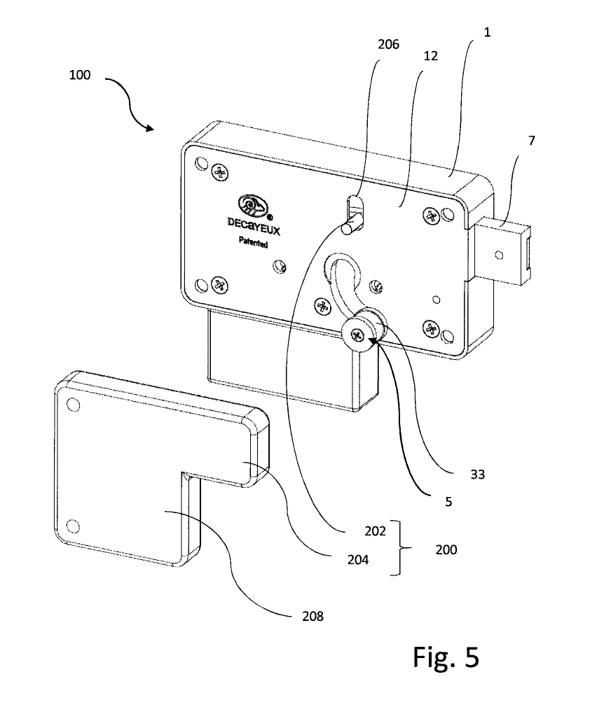

With reference to FIG. 5, another embodiment of the lock 100 is proposed. The embodiment illustrated in FIG. 5 has an operation identical with the embodiment of the lock 100 illustrated in FIGS. 1 to 4B. The embodiment of FIG. 5 differs from the embodiment of FIGS. 1 to 4B in that the lock 100 is inverted, i.e. in FIG. 5, the service cylinder 60 and the customer cylinder 70 are mounted on the lock chamber 1 and the clutch 5 is mounted on the strike plate 12. The lock chamber 1 and the strike plate 12 form a casing and a closure plate of this casing for the lock 100. Further, the head 33 of the clutch 5 includes a curved portion giving the possibility of facilitating the displacement of the clutch 5.

The embodiment of FIG. 5 also differs from the embodiment of FIGS. 1 to 4B in that the lock 100 includes a module 200 for detecting the actuation of the service cylinder 60. Thus, the lock 100 is capable of detecting the moment when the service personnel has deposited a letter or a packet inside the mailbox.

The detection module 200 includes a pin 202 configured so as to be displaced by the service cylinder 60 in a triggering position when the service cylinder 60 is actuated. In particular, the pin 202 is attached on the groove 8 so that, when the groove 8 is pivoted under the actuation of the service cylinder 60, the pin 202 is displaced into its triggering position. Alternatively, the pin 202 may be attached on any part of the lock 100 giving the possibility of displacing the pin 202 under the actuation of the service cylinder 60.

In order to allow the detection module 200 to detect the displacement of the pin 202 into the triggering position, the detection module 200 also comprises a triggering module 204 configured so as to be triggered by the pin 202 when the latter is displaced into the triggering position. The detection module 200, i.e. the pin 202 and the triggering module 204, forms an electric contactor able to be triggered by the actuation of the service cylinder 60.

In order to allow cooperation between the pin 202 and the triggering module 204, the pin 202 protrudes out of the strike plate 12 through a detection orifice 206 formed in the strike plate 12. The triggering module 204 is positioned against the strike plate 12 so that a portion of the triggering module 204 is facing the pin 202. Alternatively, in accordance with the embodiment of FIGS. 1 to 4B, the detection orifice 206 may be formed in the lock chamber 1 so that the pin 202 protrudes out of the lock chamber 1. In the latter case, the triggering module 204 is positioned against the lock chamber 1.

Further, the lock 100 includes a communication module 208 configured for transmitting a piece of information relative to the detection of the actuation of the service cylinder 60 by the detection module 200. In order to simplify the mounting and the use of the lock 100, the communication module 208 is configured for transmitting a piece of information in a wireless way. In order to transmit this piece of information, the communication module 208 includes a transmission antenna (not visible). The communication module 208 may be configured for sending SMSs, e-mails or further make telephone calls. The communication module 208 may also be configured so as to transmit this piece of information by using one or several of the following protocols: Wi-Fi, Bluetooth®, Z-Wave, ZigBee, DASH7, ANT+, SIGFOX, LORA, NFC, LIFI, 6LowPan or through a 2G, 3G or 4G mobile network.

In order to simplify the mounting of the lock 100, the triggering 204 and communication 208 modules are positioned on a same casing attached on the strike plate 12. Alternatively, the triggering 204 and communication 208 modules may be dissociated, i.e. in two distinct casings, so as to be able to position them in different locations.

In order to supply electric energy, the detection module 200 and the communication module 208, the lock 100 further includes a power supply module 210. The power supply module comprises a plurality of battery cells connected with each other for powering the detection module 200 and the communication module 208. The lock 100 is thus autonomous as regards electric power. Alternatively, any other electric energy supply means may be used. The lock 100 may for example be connected to an electricity network.

A method for transmitting a piece of information relative to the actuation of the service cylinder 60 of the lock 100 is also proposed. This method comprises the actuation of the service cylinder 60, and then the detection of the actuation of the service cylinder 60 by the detection module 200. A piece of information relative to the actuation of the service cylinder 60 is then sent by the communication module 208. This piece of information may be transmitted to the customer who owns the mailbox so as to warn him that a letter or a package has been deposited. Alternatively, the communication module 208 may be configured for transmitting this piece of information to an intermediate device responsible for warning the customer or to a database of a corporation responsible for delivering a package to the customer. Thus, when a packet delivery person maneuvers the service cylinder 60, he/she triggers the detection module 200 which generates the transmission of this piece of information, for example by sending an SMS, an email or any other means to the addressee in order to warn him/her that a package was delivered.

The method for operating a lock 100 according to the invention therefore includes steps wherein, when the clutch 5 is disengaged,

a customer locks the lock 100 by means of the customer key, by actuating the customer cylinder 70 in an anticlockwise direction,

a service personnel unlocks the lock 100 by means of the service key, by actuating the service cylinder 60 in a clockwise direction, so as to open the mailbox for depositing a package therein,

the service personnel locks the lock 100 by means of the service key so as to engage the clutch 5, by actuation of the service cylinder 60 in an anticlockwise direction,

the customer unlocks the lock 100 by the sole means of his/her customer key, by actuating the customer cylinder 70 in an anticlockwise direction, so as to open the mailbox in order to recover the package therefrom.

If the customer believes that he will receive soon another package, he/she disengages the clutch 5 for de-blocking the service cylinder 60, i.e. for making it operative. Otherwise, he leaves the clutch 5 in the engaged position. In other words, after locking the lock by actuation of the customer cylinder, the unlocking of said lock may be carried out by actuating either one of the cylinders, and, after locking of the lock by actuation of the service cylinder, the unlocking is only possible by actuating the customer cylinder. In one alternative, the clockwise and anti-clockwise directions are reversed without there being a change in the operation of the lock described earlier.

In the foregoing description as well as in the following claims, by service key and by customer key are meant any means for actuating the service and customer cylinders, respectively. For example, this actuation means may consist in an electromechanical device provided with an electric micromotor, of a micro-controller, of a data memory and a communication system. This communication system may appear as:

an alphanumeric keyboard, in which case the owner(s) of the lock and/or the postmen(man) has(have) code(s) for actuation of the cylinder(s), these codes being stored in the data memory, or else

as a chip card reader intended to receive one or more chip card(s) possessed by the owner(s) of the lock and/or the postmen(man), the data relative to these card(s) being stored in the data memory or else,

a sensor using Near Field Communication technology or Radio Frequency Identification technology for detecting in a contactless way one or more badge(s) possessed by the owner(s) of the lock and/or the postmen(man), the data relative to these badge(s) being stored in the data memory.

Of course, the present invention is not limited to the described and illustrated examples, but it may generate many alternatives accessible to one skilled in the art.

Moreover, the invention also relates to the following items:

Item 1: A double cylinder 60 lock 100; 70, the first of said cylinders, called a service cylinder 60, being actuatable by a first key, the second of said cylinders, called a customer cylinder 70, being actuatable by a second key distinct from the first key, wherein the service cylinder is only actuatable once at most between two actuations of the customer cylinder, the lock also including modules for detecting the actuation of the service cylinder.

Item 2: The lock according to item 1, further including a movable clutch 5 between a so-called disengaged position in which both cylinders are actuatable and a so-called engaged position in which only one of the cylinders is actuatable.

Item 3: The lock according to item 2, further including:

a lock chamber 1 at the bottom 20 of which is provided a notch 25 as a circular arc,

a pivoting clutch disc 4 comprising a tube 30 sliding within said notch between the disengaged position and the engaged position.

Item 4: The lock according to item 3, wherein:

the disc 4 has a through-bore 31 made in the extension of the tube 30,

the tube 30 includes at its rear end a shrinked portion,

said lock further includes a spring 19 positioned inside said tube,

the clutch is positioned inside said tube and comprises a cylindrical body 32 and a head 33.

Item 5: The lock according to item 4, wherein the body 32 of the clutch 5

has a flange 34, the diameter of which is similar to an inner diameter of the tube 30 and to an outer diameter of the spring 19 so that said spring is positioned between the shrinked portion of said tube and the flange 34 of said clutch,

crosses the bore 31 of the disc 4 on one side and crosses, on the other side said shrinked portion so that the head 33 of said clutch is on the rear side of the lock chamber 1.

Item 6: The lock according to item 4 or 5, wherein:

it further includes a so called service bit 9 comprising a protrusion 40, an oblong notch 41 and an orifice 42,

said notch receives a rotor 14 of the service cylinder 60,

said orifice receives the body 32 of the clutch 5 during the actuation of said service cylinder.

Item 7: The lock according to item 2 to 6, wherein:

it further includes a latch 11 comprising an oblong notch 45 and an orifice 46, said latch being attached to the lock chamber,

the notch of said latch receives the surface cylinder 60,

the orifice of said latch receives the body 32 of the clutch 5 when the clutch is in the engaged position.

Item 8: The lock according to one of items 1 to 7, wherein:

it further includes a so called customer bit 10 comprising a protrusion 43 and an oblong notch 44,

the notch of said customer bit receives a rotor 17 of the customer cylinder 70.

Item 9: The lock according to items 5 and 8, further including:

a bolt 6 having two lower notches 36; 37 and an oblong notch 38, one 36 of said notches being adapted for receiving the protrusion 40 of the service bit 9, the other one 37 of said notches being adapted for receiving the protrusion 43 of the customer bit 10,

a groove 8 applied against a front face of the bolt 6 on which it is mounted so as to freely rotate, said groove having a lateral notch 39,

a square 26 attached on the bottom 20 of the lock chamber 1 and adapted for sliding within the notch of the bolt and the notch of the groove.

Item 10: A method for operating a lock 100 according to one of items 1 to 9, wherein, after locking the lock by actuating the customer cylinder 70, the unlocking of the lock may be carried out by actuation of either one of the cylinders, and in that, after locking the lock by actuating the service cylinder, the unlocking is only possible by actuation of the customer cylinder.

The invention claimed is:

1. A double cylinder lock comprising:
a first of the cylinders, called a service cylinder, being actuatable by a first key;
a second of the cylinders, called a customer cylinder, being actuatable by a second key distinct from the first key;
wherein the service cylinder may only be actuated once at most between two actuations of the customer cylinder;
a module operably detecting the actuation of the service cylinder;
a closure plate and a casing in which the service cylinder and the customer cylinder are accommodated, the closure plate being configured for closing the casing, the detection module including:
a pin configured so as to be displaced by the service cylinder into a triggering position when the service cylinder is actuated, the pin being configured for protruding out of the casing or of the closure plate through a detection orifice formed in the casing or the closure plate, respectively; and
a triggering module configured so as to be triggered by the pin when the pin is displaced into the triggering position.

2. The lock according to claim 1, further comprising a communication module configured for transmitting a piece of information relative to the detection of the actuation of the service cylinder by the detection module.

3. The lock according to claim 2, wherein the communication module is configured for transmitting a piece of information by a wireless way.

4. The lock according to claim 1, further comprising a movable clutch between a so-called disengaged position in which both cylinders are actuatable and a so-called engaged position in which only one of the cylinders is actuatable.

5. The lock according to claim 4, further comprising:
a lock chamber at the bottom of which is provided a notch with shape of a circular arc; and
a pivoting clutch disc comprising a tube sliding within the notch between the disengaged position and the engaged position.

6. The lock according to claim 5, wherein:
the disc has a through-bore arranged in the extension of the tube;
the tube includes, at its rear end, a shrinked portion;
said lock further includes a spring positioned within said tube; and
the clutch is positioned within the tube and comprises a cylindrical body and a head.

7. A method for transmitting information relative to actuation of a service cylinder of a lock comprising:
a first of the cylinders, called a service cylinder, being actuatable by a first key;
a second of the cylinders, called a customer cylinder, being actuatable by a second key distinct from the first key;
wherein the service cylinder may only be actuated once at most between two actuations of the customer cylinder;
a module operably detecting the actuation of the service cylinder;
a closure plate and a casing in which the service cylinder and the customer cylinder are accommodated, the closure plate being configured for closing the casing, the detection module including:
a pin configured so as to be displaced by the service cylinder into a triggering position when the service cylinder is actuated, the pin being configured for protruding out of the casing or of the closure plate through a detection orifice formed in the casing or the closure plate, respectively; and
a triggering module configured so as to be triggered by the pin when the pin is displaced into the triggering position;
the method comprising:
actuating the service cylinder;
detecting the actuation of the service cylinder by the detection module; and
transmitting the information relative to the actuation of the service cylinder.

8. A mailbox including a double cylinder comprising:
a service cylinder being actuatable by a first key;
a customer cylinder being actuatable by a second key distinct from the first key;
wherein the service cylinder may only be actuated once at most between two actuations of the customer cylinder;
a module operably detecting the actuation of the service cylinder;
a closure plate and a casing in which the service cylinder and the customer cylinder are accommodated, the closure plate being configured for closing the casing, the detection module including:
a pin configured so as to be displaced by the service cylinder into a triggering position when the service cylinder is actuated, the pin being configured for protruding out of the casing or of the closure plate through a detection orifice formed in the casing or the closure plate, respectively; and
a triggering module configured so as to be triggered by the pin when the pin is displaced into the triggering position.
